(19) United States
(12) Patent Application Publication
(10) Pub. No.: US 2009/0003636 A1
(43) Pub. Date: Jan. 1, 2009

(54) Method and device for the program selection of a hearing aid

(75) Inventors: Heike Heuermann, Hamburg (DE); Sebastian Pape, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Instruments Pte. Ltd.

(21) Appl. No.: 12/214,971

(22) Filed: Jun. 24, 2008

(30) Foreign Application Priority Data
Jun. 26, 2007 (DE) 10 2007 029 374.9

(51) Int. Cl. H04R 25/00

(52) U.S. Cl. 381/312

(57) ABSTRACT

The invention specifies a method and an associated device for selecting at least one program in a hearing aid. By pressing a switching means, for example a push switch, once or a number of times within a defined time period it is possible to switch to one of the programs according to a number of repetitions corresponding to the program.

### CROSS REFERENCE TO RELATED APPLICATIONS

This application claims priority of German application No. 10 2007 029 374.9 filed Jun. 26, 2007, which is incorporated by reference herein in its entirety.

### FIELD OF THE INVENTION

The invention relates to a method for the program selection of a hearing aid and an associated device.

### BACKGROUND OF THE INVENTION

Numerous hearing aids are provided with the possibility of selecting different hearing programs by pushing a switch. The behind-the-ear part of the hearing aid possesses a switch for this purpose.

The switch for program selection generally requires a separate operating element as it is usually very small in design. For this purpose, a plastic button is often used which presses against a membrane switch. The button also covers and protects the membrane switch. Alternatively the switch for the program selection can also be embodied as a push button.

By pushing the plastic button or the push button it is possible to switch from one hearing program to the next. In this process the hearing programs are selected in sequence. If a hearing aid wearer for example wishes to switch in the case of four possible programs from program 2 to program 1, he must first switch to program 3 and then to program 4 before he finally reaches program 1. If the hearing aid wearer inadvertently pushes the button again, he only reaches program 1 again by pushing the button or the push button several times. This type of hearing program selection is tedious for many hearing aid wearers.

The patent publication DE 10 2005 037 897 B3 specifies a hearing aid with one such program selection procedure. Here, by slight movement of a cover device of a program switch, said program switch is activated enabling switching between hearing programs.

### SUMMARY OF THE INVENTION

It is an object of the invention to specify a method for program selection for hearing devices, which enables a simpler way of selecting programs.

According to the invention the stated object is achieved with the method by the features listed in independent claim by pressing a switch once or a number of times within a specified time period to select at least one program in a hearing aid. According to the number of times the switch is pressed a switch is made to a program according to the number of repetitions assigned to the program.

The invention brings with it the advantage that it is possible to switch to a program directly—without having to switch via programs in between. This increases the comfort and reduces the error rate.

The time period can be specified and preferably lies between 0.5 and 2 seconds.

This has the advantage that sufficient time is available for the safe operation of the switching means.

In one embodiment the program number corresponds to the number of times the switch is pressed.

It is advantageous that the hearing aid can be operated easily by assigning the first program one depression, the second program two depressions, the third program three depressions and so on.

The programs can be hearing programs of the hearing aid.

Another object of the invention consists in specifying a device corresponding to the method.

The inventive device for selecting at least one program in a hearing aid comprises a switching means for selecting a program. The switching means is arranged on the hearing aid and embodied in such a way that by pressing the switching means once or a number of times within a defined time slot it is possible to switch to a program according to a number of repetitions corresponding to the program.

The location of the switching means on the hearing aid makes it light and easy to operate.

In one embodiment the switching means comprises a push switch integrated in a behind-the-ear part of the hearing aid.

In a further embodiment the switching means comprises a membrane switch integrated in a behind-the-ear part of the hearing aid, which can be operated by a cover device covering the membrane switch.

A further object of the invention consists in specifying a scheduling program product associated with the inventive method.

This scheduling program product that can be directly loaded in an internal memory of a scheduler of the hearing aid and comprises software code portions carries out the inventive method steps when the program product runs on the scheduler.

### BRIEF DESCRIPTION OF THE DRAWINGS

Further special features of the invention will become clear from the following explanations of several exemplary embodiments with the aid of schematic drawings.

These show:

FIG. 1 a flow diagram

FIG. 2 a behind-the-ear part of a hearing aid with membrane switch, and

FIG. 3 a behind-the-ear part of a hearing aid with push switch.

### DETAILED DESCRIPTION OF THE INVENTION

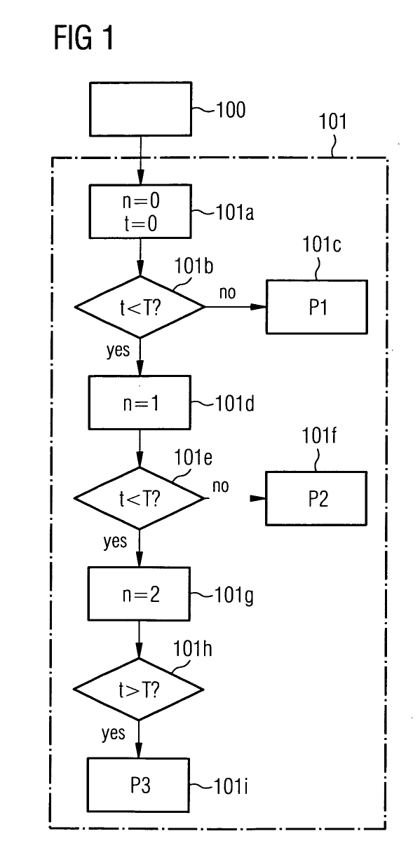

FIG. 1 shows the main method steps in selecting the third program P3. The switching means 1 is pressed with a number of repetitions WZ equal to two within a time period T, measured from the first depression.

In step 100, a hearing aid is provided with a behind-the-ear part 2. In step 101 the switching means 1 is switched within the defined time period T to the third program P3 according to a number of repetitions WZ corresponding to the program P3, which in this exemplary embodiment is two. Step 101 consists of sub-steps 101a to 101i.

In step 101a the switching means 1 is pressed for the first time. A counter n is set to “0” and a time counter t is also set to “0” and started. In step 101b it is then checked whether the time counter t is smaller than the predetermined time period T. If not, step 101c is carried out by switching to the first program P1. Step 101 is then completed. If the time counter t is smaller than the time period T, step 101d follows, in which the button 2 is pressed for the second time. The counter n is set to “1”. Then in step 101e, it is checked again whether the time counter t is still smaller than the predetermined time period T. If not, step 101f is carried out by switching to the second program P2. Step 101 is then completed. If the time counter t is still smaller than the time period T, step 101g follows, in which the switching means 2 is pressed for the third time. The counter n is set to “2” and is then equal to the predetermined number of repetitions WZ. Once the predetermined time period T has elapsed in step 101i, a switch is made to the third program P3 and step 101 is then finished.

A new program selection can now be started again if required.

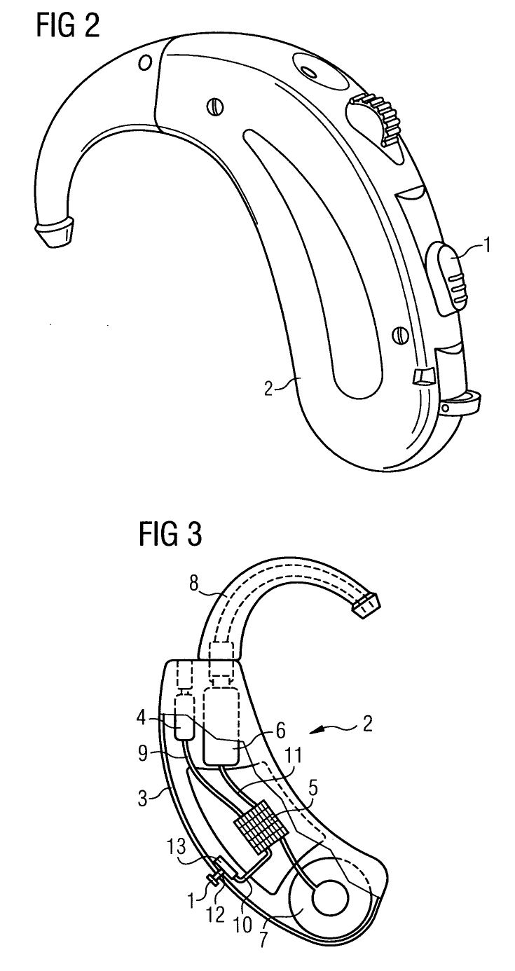

FIG. 2 shows a behind-the-ear part 2 of a hearing aid with a switch cover 1 beneath which a non-visible membrane switch is located. By applying slight pressure to the switch cover 1 it is possible to switch to the desired hearing program directly by triggering one or more switch contacts within a defined time period T. A programming connector for example according to the CS44 standard can also be arranged beneath the switch cover 1.

FIG. 3 shows a view of an inventive exemplary embodiment of a behind-the-ear part 2 of a hearing aid with a switching means 1 in the form of a push button. With regard to the behind-the-ear part 2 illustrated, arranged inside the hearing aid housing 3 formed of plastic shells are electrical components such as a microphone 4, an amplifier unit together with a switch contact evaluation unit 5, a receiver 6 and a battery 7 as the power source. To enable it to be worn on the ear, an ear hook 8 is fastened to the hearing aid housing 3. The switching circuit of the amplifier unit 5 and the electroacoustic transducers 4, 6 are connected to the power supply 7 by means of electric conductor connections 9, 10, 11.

For program selection an operating device 1 embodied as a push switch 1 is held in the hearing aid housing 3 with the aid of a connector 12. The conducting contacts, conductor paths or switch contacts of said operating device arranged on a circuit board 13 can also be connected by means of conducting connections 10 to the switching circuit of the amplifier unit 5.

It is possible to switch to the desired hearing programs directly by pressing the push switch 1 once or a number of times within the defined time period T.

In a further embodiment the inventive arrangement is integrated in an in-the-ear hearing aid. Instead of a membrane switch an optical switch can also be used.

1.-10. (canceled)

11. A method for selecting a program in a hearing aid, comprising:
assigning a number of repetitions for pressing a switching unit of the hearing aid to the program;
pressing the switching unit the number of repetitions within a time period; and
selecting the program according to the number of repetitions assigned to the program.

12. The method as claimed in claim 11, wherein the time period is predetermined.

13. The method as claimed in claim 11, wherein the time period is less than 2 seconds and greater than 0.5 seconds.

14. The method as claimed in claim 11, wherein the program comprises a program number.

15. The method as claimed in claim 14, wherein the number of repetitions assigned to the program corresponds to the program number.

16. The method as claimed in claim 11, wherein the program is a hearing program.

17. A device for selecting a program in a hearing aid, comprising:
a switching unit that switches to the program by pressing the switching unit a number of repetitions assigned to the program within a time period.

18. The device as claimed in claim 17, wherein the switching unit comprises a push switch.

19. The device as claimed in claim 17, wherein the switching unit comprises a membrane switch.

20. The device as claimed in claim 19, wherein the membrane switch is covered by a cover device for activating the membrane switch.

21. The device as claimed in claim 17, wherein the switching unit is integrated into a behind-the-ear part of the hearing aid.

22. A computer program loaded into a hearing aid for selecting a hearing program in the hearing aid, comprising:
a program code that:
assigns a number of repetitions for pressing a switching unit of the hearing aid to the hearing program, and
selects the hearing program according to the number of repetitions assigned to the hearing program.
